(19) United States
(12) Patent Application Publication
(10) Pub. No.: US 2011/0296362 A1
(43) Pub. Date: Dec. 1, 2011

(54) SEMICONDUCTOR DEFECT INTEGRATED PROJECTION METHOD AND DEFECT INSPECTION SUPPORT APPARATUS EQUIPPED WITH SEMICONDUCTOR DEFECT INTEGRATED PROJECTION FUNCTION

(76) Inventors: Tamao Ishikawa, Hitachinaka (JP); Yutaka Tandai, Hitachinaka (JP); Shigeki Kurihara, Hitachinaka (JP)

(21) Appl. No.: 13/147,899

(22) PCT Filed: Feb. 1, 2010
(86) PCT No.: PCT/JP2010/051319

§ 371 Date: Aug. 4, 2011

(30) Foreign Application Priority Data
Feb. 4, 2009 (JP) 2009-023178

(51) Int. Cl. G06F 17/50

(52) U.S. Cl. 716/112

(57) ABSTRACT

The present invention comprises: a design layout data read part that acquires design layout data including location information of design circuit patterns used in steps of semiconductor fabrication; a wafer-chip information read part that acquires, from among data concerning a wafer on which a plurality of the design circuit patterns are formed per chip, wafer-chip information including at least design cell location information; a defect data read part that acquires defect data including location information of defects that occurred in the steps; a design layout data tracing processing part that creates a design layout data defect integrated projection display view by performing, based on the design layout data and the wafer-chip information, an integrated projection process on, among the design layout data, design layout data for a step in which a defect occurred and the defect data; and a defect integrated projection display apparatus that displays the design layout data defect integrated projection display view.

### TECHNICAL FIELD

The present invention relates to an inspection support technique for improving the operability and convenience of various devices by processing data obtained at an inspection apparatus or defect review apparatus in which fine circuit patterns are formed, such as semiconductor devices, liquid crystal devices, etc., and providing feedback to the various devices.

### BACKGROUND ART

In fabrication steps for semiconductor devices, for the purpose of finding foreign substance defects such as adhesion of a foreign substance, etc., and investigating the cause, optical pattern inspection apparatuses, which detect the locations of defects by comparing similar circuit patterns of a plurality of LSIs using optical images, SEM-based pattern inspection apparatuses, which detect the locations of structural or electrical defects in a circuit pattern through comparative operational processing similar to that of the optical pattern inspection apparatus using an electron beam image of a higher resolution than optical images by applying the technology of scanning electron microscopes (SEM), and the like, are generally used. Further, defect review apparatuses that image detected defect locations with high precision and automatically execute a classification process for each defect type (ADC: Automatic Defect Classification) and the like have also been put to practical use.

These inspection apparatuses are generally deployed per fabrication step for each layer constituting a semiconductor device, and detect defects through foreign substance inspection and circuit pattern inspection. By having their types identified and their occurrences tallied per type, the detected defects are used as information for determining whether the fabrication steps are good or bad.

As one such defect detection method, by way of example, Patent Document 1 discloses an invention that compares fault distribution image data, or fault distribution contrast image data, created per fabrication step to find a fault that is not detected in a given fabrication step but is detected in a given fabrication step, thereby revealing the fabrication step that caused the fault to occur. Then, depending on the nature of the detected defect, such fabrication countermeasures as design modifications, fabrication condition alterations, etc., are taken.

Further, in Patent Document 2, there is disclosed an inspection method in which image information obtained from an optical inspection apparatus is compared with a design pattern of a semiconductor device to determine whether a detected defect is critical or non-critical in accordance with the extent of overlap between the defect and the wiring pattern. What is really needed as information for determining whether a given fabrication step is good or bad is the frequency with which critical defects occur, and from the perspective of improving inspection speed, a function that only detects critical defects while ignoring non-critical defects is often demanded of inspection apparatuses.

Further still, Patent Document 3 discloses an invention relating to an EB tester in which an electron beam irradiation location is specified relative to a design pattern. Here, the term EB tester refers to an inspection apparatus for testing whether or not a finished chip on a wafer operates as a circuit by irradiating it with an electron beam. With respect to the invention disclosed in Patent Document 3, in specifying the electron beam irradiation location relative to the design pattern, by changing the image to be displayed on a GUI to an image of a protective film pattern on the wiring pattern instead of an image of the wiring pattern that is to be inspected, image matching precision between the design pattern and the actual SEM image is improved, thereby improving the precision for when the irradiation location of the electron beam is automatically determined.

### PRIOR ART DOCUMENTS

### Patent Documents

Patent Document 1: JP Patent Publication (Kokai) No. 11-45919 A (1999)
Patent Document 2: JP Patent Publication (Kokai) No. 2000-311924 A
Patent Document 3: JP Patent Publication (Kokai) No. 2000-266706 A

### SUMMARY OF THE INVENTION

### Problems to be Solved by the Invention

However, defects for which causes cannot be determined with the above-mentioned inspection apparatuses alone are beginning to increase. Therefore, there is a problem in that it takes time and is costly to determine from the detected defect information whether or not the essential cause stems from design layout data.

In addition, with respect to semiconductor fabrication in recent years, as they have become finer in keeping with improvements in the level of integration, the proportion of defects physically stemming from design layout data is beginning to increase. When there are numerous such defects, there are no effective means for considering problem prevention by determining the influence thereof; such as reviewing circuit design, altering fabrication conditions, etc.

Further, it is difficult to determine the location at which a defect found by the inspection apparatus occurred with respect to whether it is a defect of the next step or a defect of an upper layer or above. Thus, there is a problem in that it is difficult to take quick action for product shipment that guarantees reliability.

With respect to semiconductor fabrication processes, as they have become finer in keeping with improvements in the level of integration, defects stemming from design are beginning to increase more than defects stemming from fabrication processes, and it is becoming an issue to improve yield by quickly finding the cause of defects stemming from design and to reflect it in design.

The present invention is made in view of such problems, and provides a means that efficiently finds a cause stemming from design layout data by displaying information related to a defect found by an inspection apparatus or a defect found by an inspection review apparatus by integrating it with design layout data, and enabling analysis.

### Means for Solving the Problems

The present invention utilizes design layout data of a semiconductor, and performs integrated projection of defects per chip onto the design layout data. In addition, it simultaneously performs integrated projection of an image imaged by a defect review apparatus at the time of defect discovery and of corresponding design layout data as well as any given design layout data, displays circuit patterns of a lower layer and an upper layer, and supports analysis of a defect site by switching the display of those circuit patterns.

Specifically, a semiconductor inspection support apparatus of the present invention comprises: a design layout data read part that acquires design layout data including location information of design circuit patterns to be used in semiconductor fabrication steps; a wafer-chip information read part that acquires, from among data concerning a wafer on which a plurality of the design circuit patterns are formed per chip, wafer-chip information including at least design cell location information; a defect data read part that acquires defect data including location information of defects that occurred in the steps; a design layout data tracing processing part that creates a design layout data defect integrated projection display view by performing, based on the design layout data and the wafer-chip information, an integrated projection process on, among the design layout data, design layout data for a step in which a defect occurred and the defect data; and a defect integrated projection display apparatus that displays the design layout data defect integrated projection display view.

### Effects of the Invention

With the present invention, determining the cause of a defect that has been found and that stems from design layout data, identifying its type, and determining its level of influence on the chip as a whole are made easier. Further, it is possible to study defect information in a multifaceted and multilayered fashion. With that as useful information for considering defect countermeasures, it is consequently possible to improve yield.

### BRIEF DESCRIPTION OF THE DRAWINGS

FIG. 1 is an illustration of a semiconductor defect integrated projection system according to Embodiment 1.

FIGS. 2(A) through 2(C) show display examples of defect integrated projection displays according to Embodiment 1. FIG. 2(A) is a display example of die defect integrated projection, FIG. 2(B) is a display example of chip defect integrated projection, and FIG. 2(C) is a display example of design cell defect integrated projection.

FIGS. 3(A) through 3(E) show display examples of integrated projection displays of a defect and design layout data according to Embodiment 1. FIG. 3(A) is a display example of die defect integrated projection, FIG. 3(B) is a design layout data enlarged display example of a defect site, FIG. 3(C) is an arbitrary design layout data enlarged display example, FIG. 3(D) is a superimposed enlarged display example of design layout data of a defect site and a plurality of arbitrary design layout data, and FIG. 3(E) is a superimposed enlarged display example of an imaged image and arbitrary design layout data.

FIG. 4 is a diagram showing a flowchart for a defect integrated projection means according to Embodiment 1.

FIGS. 5(A) through 5(E) are conceptual diagrams indicating the fact that a pattern of a given layer is formed by superimposing design patterns of a plurality of layers. FIG. 5(A) is a design pattern corresponding to upper layer pattern 2 (dummy pattern). FIG. 5(B) is a design pattern corresponding to upper layer pattern 1 (active pattern). FIG. 5(C) is a design pattern corresponding to an intermediate layer pattern (active pattern). FIG. 5(D) is a design pattern corresponding to a lower layer pattern (active pattern). FIG. 5(E) is a design pattern of a given layer that is formed by superimposing the design patterns in FIGS. 5(A) through (D).

FIG. 6 is a layout diagram showing a defect inspection support apparatus according to Embodiment 2 and its surrounding environment.

FIG. 7 is a functional block diagram for realizing a defect integrated projection means according to Embodiment 2.

FIGS. 8(A) through 8(C) show a background diagram synthesized while differentiating between an active pattern and a dummy pattern. FIG. 8(A) is a design pattern corresponding to an active pattern. FIG. 8(B) is a design pattern corresponding to a dummy pattern. FIG. 8(C) is a design pattern in which the design patterns shown in FIGS. 8(A) and (B) are superimposed.

FIGS. 9(A) through 9(C) show a defect integrated projection image synthesized while differentiating between an active pattern and a dummy pattern. FIG. 9(A) is an inspection image before being synthesized into a defect integrated projection image. FIG. 9(B) is a wiring pattern as designed that becomes the background. FIG. 9(C) is a defect projection image after a defect-background synthesizing process.

FIGS. 10(A) through 10(D) show display images before and after critical defect screening. FIG. 10(A) is a defect map diagram showing a wafer as a whole before critical defect screening. FIG. 10(B) is a defect map diagram showing a wafer as a whole after critical defect screening. FIG. 10(C) is an enlarged view of a portion of a cell before critical defect screening. FIG. 10(D) is an enlarged view of a portion of a cell after critical defect screening.

FIGS. 11(A) through 11(C) show a schematic view of a defect integrated projection image that is synthesized using design layout data for a layer other than that of an inspection image. FIG. 11(A) is an inspection image. FIG. 11(B) is design layout data of a downstream step. FIG. 11(C) is a defect integrated projection image after FIGS. 11(A) and (B) have been synthesized.

### MODES FOR CARRYING OUT THE INVENTION

Semiconductor defect integrated projection systems according to embodiments of the present invention are described below with reference to the appended drawings. However, it should be noted that these embodiments are merely examples for realizing the present invention, and that they do not by any means limit the technical scope of the present invention. In addition, features shared across the various drawings are designated with like reference numerals.

### Embodiment 1

### Configuration of Semiconductor Defect Integrated Projection System

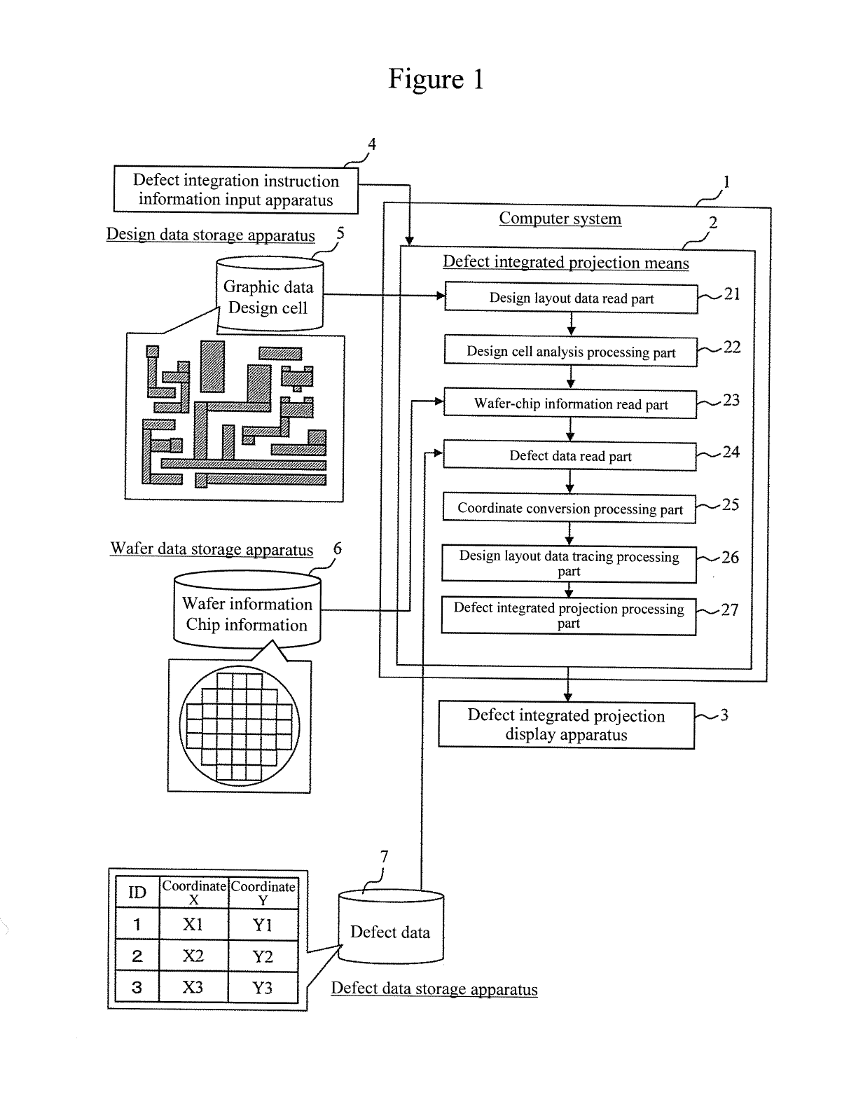

FIG. 1 is an illustration of a semiconductor defect integrated projection system showing an embodiment of the present invention.

The semiconductor defect integrated projection system comprises: an inspection support apparatus comprising a computer system 1 equipped with a defect integrated projection means 2; a defect integration instruction information input apparatus 4 that provides to the defect integrated projection means 2 an instruction from the user; a design data storage apparatus 5 that stores fabrication step information of design layout data for a semiconductor chip, mask information, design circuit pattern location information, design cell location information, layer IDs (ID information: Identification Information) as identification information for layers to which given design patterns belong, etc.; a wafer data storage apparatus 6 that stores die location information relative to a wafer, chip location information, design circuit pattern location information and design cell location information relative to a chip, wafer IDs or chip IDs as identification information for wafers or chips, fabrication step information, imaged data, etc.; a defect data storage apparatus 7 that stores location information, classification information, etc., of defects that occurred in each fabrication step; and a defect integrated projection display apparatus 3 that performs defect integrated projection with design layout data by means of the defect integrated projection means 2. Operations of the defect integrated projection means 2 will be discussed later.

It is noted that the configuration may also be such that the design data storage apparatus 5, the wafer data storage apparatus 6 and the defect data storage apparatus 7 are connected via a network. Alternatively, the configuration may also be such that the various data are stored on a portable recording medium, inputted to a computer system and processed.

<Display of Design Layout Data Defect Integrated Projection>

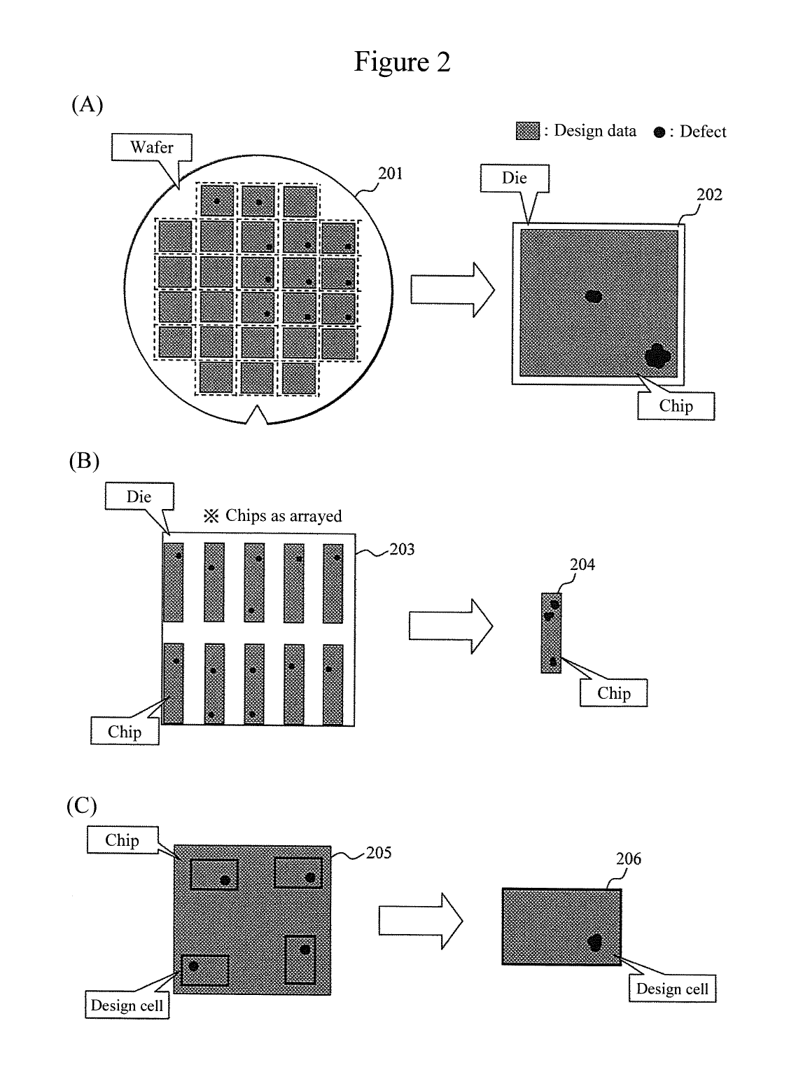

Examples of defect integrated projection displays in which a defect display is projected onto design layout data are shown in FIGS. 2(A) through 2(C). Here, integrated projection displays of defect information and design layout data are performed from larger units to smaller units in the order of wafer, die, chip and cell.

(Example of Die Defect Integrated Projection Display)

201 is a diagram in which defect information (black dots) of a plurality of dies in an array on an inspection wafer and design layout data are displayed by integrated projection.

202 is a diagram in which defect information 201 with respect to the wafer is displayed by integrated projection per die.

(Example of Chip Defect Integrated Projection Display)

In some cases, a plurality of semiconductor chips are formed on a die, and the plurality of chips collectively operate as one semiconductor device. 203 is a diagram in which defect information (black dots) of a plurality of chips in an array on a die and design layout data are displayed by integrated projection.

204 is a diagram in which, under the circumstances above, defect information with respect to the die is displayed by integrated projection per chip.

(Example of Design Cell Defect Integrated Projection Display)

205 is a diagram in which defect information (black dots) of a plurality of cells in an array on a chip and design layout data are displayed by integrated projection.

206 is a diagram in which defect information 205 with respect to the chip is displayed by integrated projection per cell.

By thus utilizing the design layout data that are used in the fabrication steps, it becomes possible to monitor defect information per wafer, per die, per chip, or per cell, respectively, with ease, and to study the effects of such defects on chips.

<Enlarged Display of Design Layout Data Defect Integrated Projection>

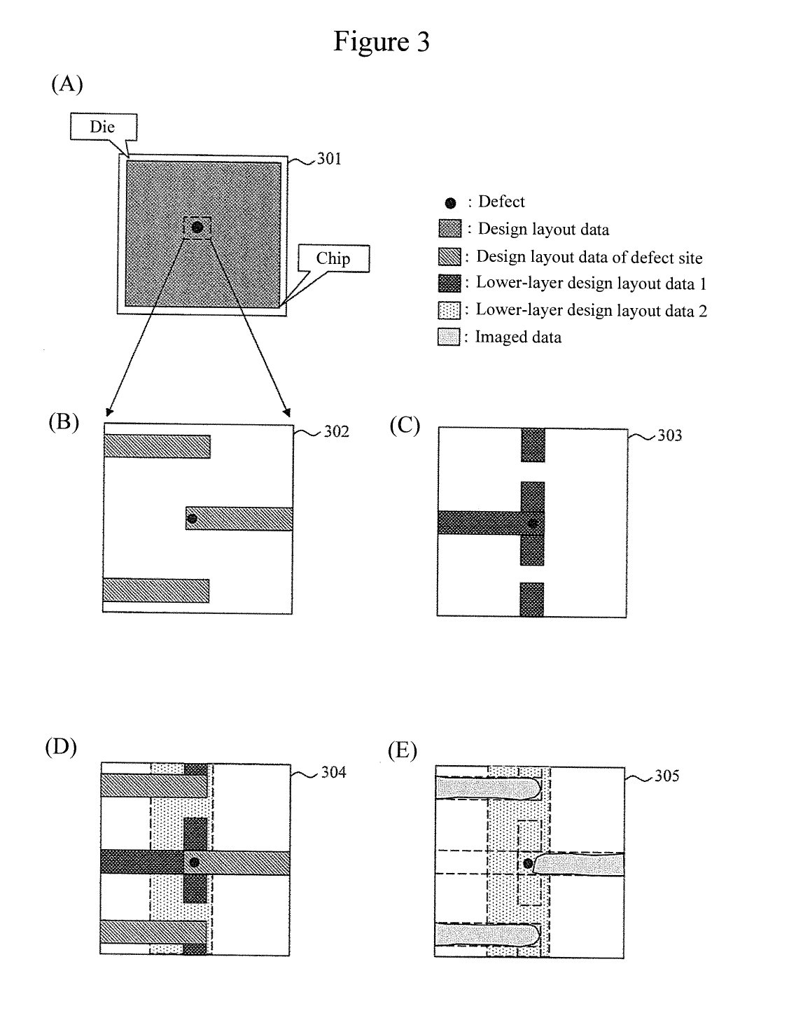

Enlarged display examples of design layout data defect integrated projection are shown in FIGS. 3(A) through 3(E). Here, taking into consideration the problem that the defect state cannot be told from the chip as a whole, it is made possible to automatically or manually enlarge and display the defect part. In addition, it is made possible to display on a screen a defect location with respect to, of the respective design layout data corresponding to the respective steps for fabricating one chip, the design layout data corresponding to the step at the time of inspection.

301 is a diagram in which defect information is displayed by integrated projection on design layout data per die by the defect integrated projection means 2. The defect location is indicated with a black dot.

302 is a display example of a case where the defect site of interest is enlarged.

Thus, it is possible to readily determine on a screen which wiring pattern the defect is located in among the design layout data for the step in which the defect was found, and it is possible to determine/monitor the effects of that defect.

However, if the cause/type of the defect cannot be determined based solely on the design layout data for the step in which the defect was found, there arises a need to compare it with and study arbitrary design layout data. In this case, the arbitrary design layout data might be, by way of example, design layout data corresponding to a step before the step in which the defect was found or to a lower layer, etc. By knowing the connective wiring, elements, etc., which are peripheral information for a defect site with respect to the design layout data for a given step, it is possible to determine the effects that the defect site has on the chip as a whole or its severity. In addition, from such information, it is made possible to analyze the cause/type of the defect, thereby also making it possible to prevent similar defects from occurring. For the reasons above, it is necessary to display by switching to a display of arbitrary design layout data, not just the design layout data for the step in which the defect was found.

303 is a diagram in which the defect part is enlarged, and the design layout data for the step in which the defect was found and arbitrary design layout data are displayed in a superimposed manner. Thus, even with respect to a defect for which the cause cannot be determined based solely on the pattern of the design layout data for the step in which the defect was found, it becomes possible to readily determine the cause/type of the defect.

In addition, if the cause, etc., of a defect is difficult to determine based solely on the design layout data for the step in which the defect was found, such as when the fabrication steps are complicated, etc., it is necessary to display design layout data for a plurality of steps (or lower layers) associated therewith and the defect in a superimposed manner. 304 is an example in which the defect part is enlarged, and design layout data for a plurality of steps are displayed in a superimposed manner. It thus becomes possible to more readily and quickly see the state of the wiring pattern of the defect. Here, if the wiring patterns of the respective design layout data are to be displayed simultaneously, in order to distinguish the wiring patterns, they are displayed with their colors, fill patterns, etc., arbitrarily varied. It thus becomes possible to readily discern the wiring patterns for the respective design layout data.

Further, if coordinate data of an image imaged by a defect review apparatus not shown in the drawings is acquired, by aligning the coordinates of this image with design layout data, it is also possible to superimpose a defect image. 305 is an example in which a defect part is enlarged, and an imaged image and design layout data are displayed in a superimposed manner. In this case, design layout data for a plurality of steps may be displayed in a superimposed manner if necessary. By thus simultaneously displaying not only the defect data of the inspection apparatus but also the design layout data and making comparisons, determinations of a defect stemming from design data are made easier, and it becomes possible to determine the effects of such a defect and to effectively take countermeasures with respect to fabrication.

<Process by Defect Integrated Projection Means>

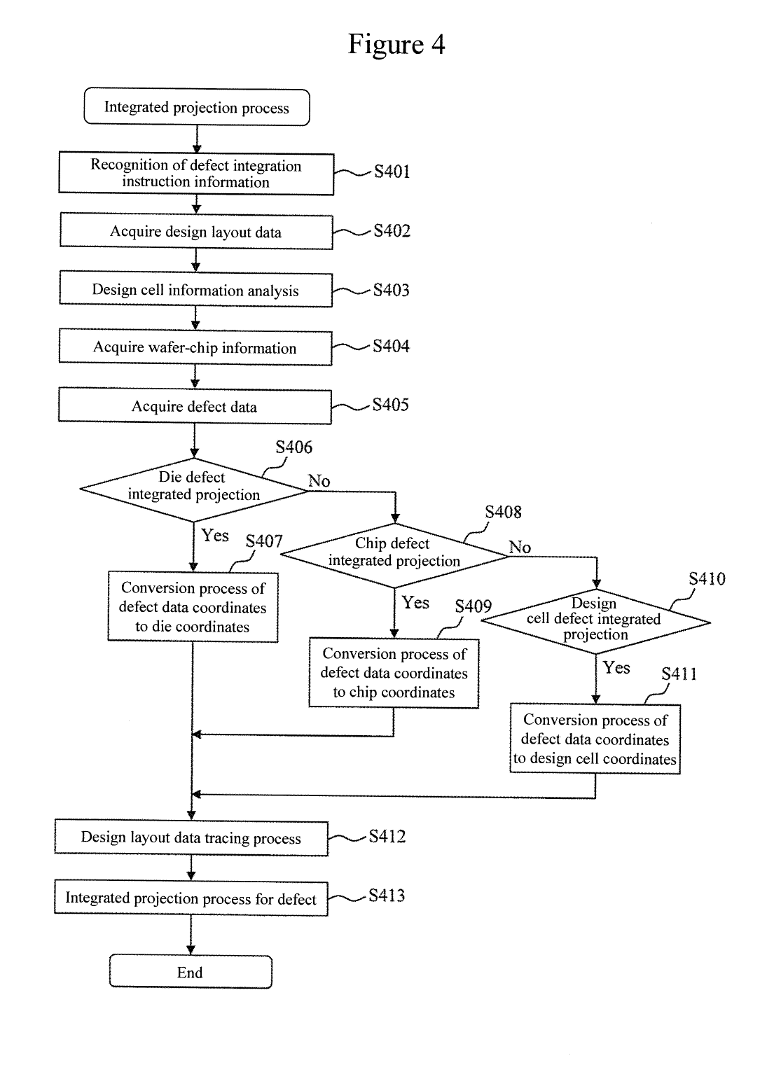

A flowchart for a process of integrated projection by the defect integrated projection means 2 is shown in FIG. 4.

First, there is displayed on the defect integrated projection display apparatus shown in FIG. 1 a GUI screen for entering information that is necessary for instructing defect integration. The term necessary information refers to the layer number (identifier) for the layer where the defect for which a criticality determination is to be made is located, and the size of the region for which defect integration is to be performed, that is, classification information as to which method defect integration is to be executed by as selected from per die, per chip and per cell. The apparatus user enters each of the above-mentioned information on the GUI screen using the defect integration instruction information input apparatus 4, which is a keyboard-, mouse-, etc., based input means. A design cell analysis processing part 22 recognizes a defect integrated projection method, which will be described later, from the input information (S401).

Next, a design layout data read part 21 of the defect integrated projection means 2 acquires, based on the input information provided at S401, from the design layout data storage apparatus 5 a design circuit pattern, etc., of the corresponding design layout data (graphic data) (S402).

Next, the design cell analysis processing part 22 analyzes, based on the design layout data acquired at S402, the design cell of the design layout data (S403). Here, it is recognized which design layout data the defect data to be associated is, which design cell part of which step it is located at, etc. In addition, coordinate information by region, such as memory cells, etc., is included in the design layout data, and a chip can also be divided into cells using this.

Next, a wafer-chip information read part 23 acquires from the wafer data storage apparatus 6 relevant wafer and chip information based on the input information of S401 (S404). The information acquired here mainly is location information of dies in an array on a wafer, chip location information, location information of circuit patterns and design cell location information with respect to a chip, wafer imaged data, etc.

Next, a defect data read part 24 acquires from the defect data storage apparatus 7 relevant defect data based on the input information of S401 (S405). The defect data comprises coordinate information to which an ID for identification is assigned so as to enable identification of the defect.

Next, the computer system 1 determines the defect integrated projection method that was entered and instructed at S401. This determination operation is executed by communicating to a coordinate conversion processing part 25 information on the defect integrated projection method that was recognized by the design cell analysis processing part 22 at S401.

First, it is determined whether or not the defect integrated projection method is die defect integrated projection (S406). If the result of the determination of S406 is die defect integrated projection, the coordinate conversion processing part 25 converts the defect data coordinates to die coordinates (S407). The coordinate conversion operation will now be discussed in detail. Semiconductor devices are fabricated by transferring circuit patterns onto the entire surface of a wafer. Thus, in principle, as long as pattern information of the entire layout pattern is available, semiconductor device fabrication is possible. However, when a portion of a layout pattern is to be locally displayed on a screen in, for example, modifying layouts, etc., calling up the layout pattern of the wafer as a whole, and displaying a portion on the screen by zooming in or zooming out would place a substantial load on the processor executing image processing. Therefore, not only the layout pattern of the wafer as a whole, but also local layout patterns, that is, pattern data of parts only are prepared, and if the enlargement factor or reduction factor for zooming in or zooming out falls outside of a given range, the local layout pattern discussed above is called up and displayed on the screen. Such local layout patterns are prepared in size units that serve as units of pattern repetition, as in dies, chips, design cells, etc., and are stored in the design data storage apparatus 5.

Such local layout pattern data each have their own unique coordinate system, and location information of line diagrams representing circuit patterns are expressed through such unique coordinate systems. In principle, it is possible to express location information of local layout patterns through a coordinate system through which the layout pattern for the entire wafer is described. However, since the numerical values representing the location information would become too large, expressing it through a coordinate system for describing a local layout pattern mitigates the load on the processor.

Both the coordinate system for the wafer as a whole and the coordinate systems for local layout patterns are basically expressed through XY orthogonal coordinate systems. Thus, the coordinate system of the wafer as a whole and the local coordinate systems are mutually convertible by adding/subtracting a predetermined origin offset amount. Origin offset amounts between the coordinate system of the wafer as a whole and the local coordinate systems are defined per identifier indicating the type of the local layout pattern, for example, per ID as in die ID, chip ID, and design cell ID. Based on the ID called up from the wafer data storage apparatus 6, the coordinate conversion processing part 25 reads out an origin offset amount from the design data storage apparatus 5, and sets the origin of the coordinate system for the local layout pattern.

On the other hand, defect location information is acquired at the inspection apparatus, and the defect location information stored in the defect data storage apparatus 7 shown in FIG. 1 is information that is expressed through the coordinate system that the inspection apparatus has. Therefore, in order to project a defect location on a circuit pattern, it is necessary to convert the coordinate system of the defect location to the coordinate system of the layout pattern. Specifically, with respect to some suitable reference location on the wafer (e.g., orientation flats, suitable die corner coordinates, etc.), the difference between a value expressed through the coordinate system of the layout pattern and a value expressed through the coordinate system of the inspection apparatus is calculated, and that difference value is defined as the origin offset amount between the coordinate system of the layout pattern and the coordinate system of the inspection apparatus. This process of defining the origin offset amount is referred to as origin alignment and is executed by the coordinate conversion processing part 25.

In the case of S407, coordinate conversion of defect coordinates to die coordinates is executed. Therefore, the coordinate conversion processing part 25 first executes origin alignment to align the origins of the layout pattern coordinate system and the inspection apparatus coordinate system. Next, it recognizes the origin offset amount based on the die ID of the die to be displayed on the screen and adds it to the coordinate information of the defect location, thereby executing coordinate conversion to die coordinates. It is noted that, if the coordinates of the defect data are stored in terms of die coordinates that the inspection apparatus has, origin alignment is executed only between the coordinate system representing the die coordinates of the inspection apparatus and the coordinate system of the die with respect to the layout pattern, and origin offset adjustment from the coordinate system of the wafer as a whole to the coordinate system of the die is not performed.

If the result of the determination of S406 is something other than die defect integrated projection, it is determined whether or not the defect integrated projection method is chip defect integrated projection (S408). If the result of the determination of S408 is chip defect integrated projection, the coordinate conversion processing part 25 converts the defect data coordinates to chip coordinates (S409). The coordinate conversion execution procedure is executed in a similar fashion to die defect integrated projection. It is noted that, if the defect data coordinates are stored in terms of chip coordinates, coordinate conversion processing is unnecessary.

If the result of the determination of S408 is something other than chip defect integrated projection, it is determined whether or not the defect integrated projection method is design cell defect integrated projection (S410). If the result of the determination of S410 is design cell defect integrated projection, the coordinate conversion processing part 25 converts the defect data coordinates to design cell coordinates (S411). The coordinate conversion execution procedure is similar to those for die defect integrated projection and chip defect integrated projection. It is noted that, if the defect data coordinates are stored in terms of design cell coordinates, coordinate conversion processing is unnecessary.

By thus performing a coordinate conversion process corresponding to the type of the local layout pattern, defect integrated projection becomes possible, where defect location information is displayed superimposed on the layout pattern.

Next, once defect data coordinate conversion is completed, a design layout data tracing processing part 26 traces design layout data that is to serve as a basis for display. The location and magnification of the design layout data to be displayed are determined, and a determination of the layer (step/process) of the design layout data to be traced and determinations of a display color and fill pattern are made (S412). In configuring layer settings, settings may be configured in such a manner as to treat a plurality of design layers as one layer, and such settings as inverted display of the upper and lower layers, or turning on/off display for the upper and lower layers, etc., are configured. It is noted that, if imaged data corresponding to the design layout data acquired at S402 is available, it may be displayed superimposed on the design layout data.

Next, once the tracing of design layout data is completed, a defect integrated projection processing part 27 performs integrated projection display of a defect on the design layout data that has been traced (S413).

Finally, the defect integrated projection display apparatus 3 displays a traced diagram of design layout data defect integrated projection.

<Miscellaneous>

It is noted that the present invention may also be realized through program code of software for realizing the functions of the embodiments. In this case, a storage medium on which the program code is recorded is supplied to a system or an apparatus, and a computer (or a CPU or MPU) of that system or apparatus reads the program code stored on the storage medium. In this case, the program code itself that is read from the storage medium would realize the aforementioned functions of the embodiments, and the program code itself as well as the storage medium storing it would constitute the present invention. As storage media for supplying such a program code, by way of example, floppy (registered trademark) disks, CD-ROMs, DVD-ROMs, hard disks, optical disks, magneto-optical disks, CD-Rs, magnetic tapes, non-volatile memory cards, ROMs, etc., may be used.

In addition, based on instructions of the program code, the OS (operating system), etc., running on the computer may perform part or all of the actual processing, having the aforementioned functions of the embodiments realized through such processing. Further, it is also possible to have, once the program code read out from the storage medium is written to the memory of the computer, the CPU, etc., of the computer perform part or all of the actual processing based on instructions of the program code, realizing the aforementioned functions of the embodiments through such processing.

In addition, by distributing, via a network, program code of software that realizes the functions of the embodiments, the program code may be stored on a storage means, such as a hard disk, memory, etc., of the system or apparatus or on a storage medium, such as a CD-RW, CD-R, etc., and a computer (or CPU or MPU) of the system or apparatus may read out and execute the program code stored on the storage means or the storage medium at the time of use.

### Embodiment 2

As discussed under [Background Art], in semiconductor device fabrication processes, defects stemming from design are beginning to increase in recent years, and it is now an issue to quickly find the cause of defects stemming from design, reflect it in the design, and improve yield. For this reason, inspection apparatuses into which a design layout referencing function is incorporated as disclosed in Patent Documents 1 to 3 have conventionally been used.

However, inspection apparatuses used in semiconductor fabrication processes are such that one unit is deployed per fabrication step. Consequently, there is a constraint in that the information obtained from each apparatus is generally defect information for the same layer. In modern semiconductor devices, the miniaturization of circuit structures and the reduction in physical distance between the upper and lower layers have progressed, and it cannot be identified which layer a defect has occurred in based solely on information obtained from a single layer. Thus, cases in which it cannot be determined whether a fabrication step is good or bad are beginning to increase.

In order to identify such defect occurring layers, it is necessary to integrate defect information of a plurality of layers. In order to realize such a function with conventional inspection apparatuses, it would be necessary to connect a plurality of inspection apparatuses, and to aggregate defect information at one of them. Information processing apparatuses that conventional inspection apparatuses are equipped with specialize heavily in image processing for defect detection. In order to realize a processing function for aggregated defect information as mentioned above, information processing apparatuses that current inspection apparatuses are equipped with are insufficient in terms of performance. If the function were to be implemented regardless, the circuit size would become very large, and there would thus be a problem in that costs associated with defect inspection would be prohibitive.

For this reason, in actual semiconductor fabrication lines, inspection results outputted from various inspection apparatuses are often aggregated at one information processing apparatus (server), and the identification of bad fabrication steps and the analysis of fabrication processes are often executed at the server.

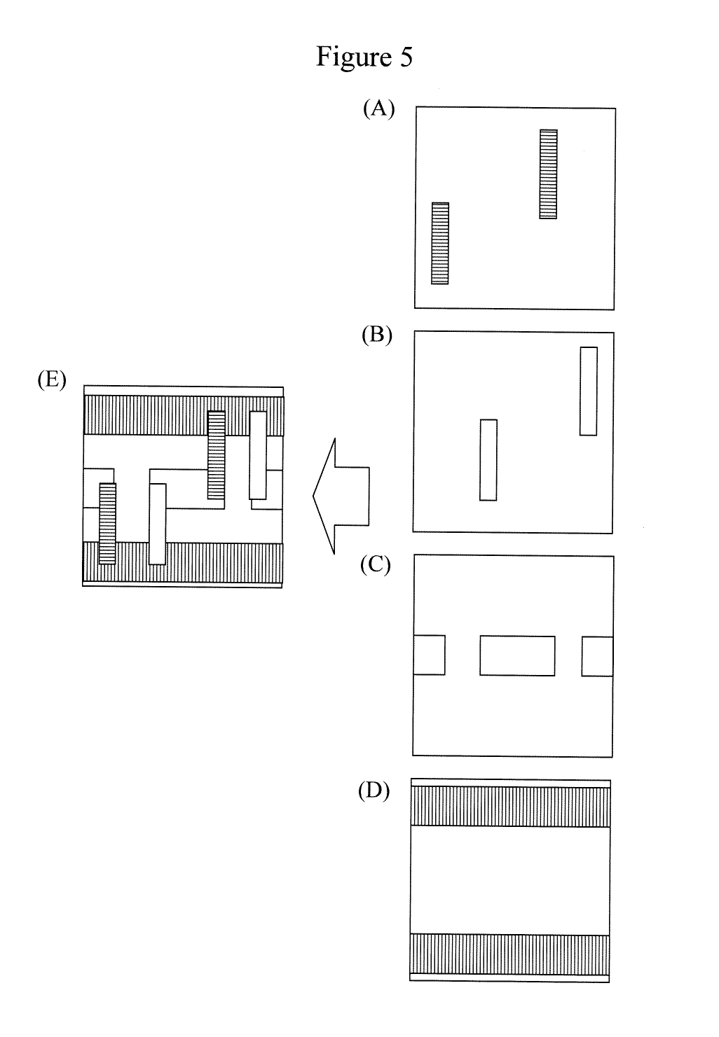

However, the layers within semiconductor devices are ordinarily formed by way of a plurality of fabrication processes, and there are a plurality of corresponding design layout information. In addition, in recent years, circuit design for semiconductor devices has become complex, and circuit elements which are not directly relevant to the operation of the device, such as dummy patterns, test circuits, etc., are often placed within devices. By way of example, in FIGS. 5(A) through 5(E), it is assumed that a given layer of a semiconductor device comprises patterns of three layers, namely, an upper layer, an intermediate layer and a lower layer, and further that the upper layer pattern is formed by exposing two patterns, namely an upper layer pattern 1 and an upper layer pattern 2. Of the above, if the upper layer pattern 2 were a dummy pattern, a defect found in the upper layer pattern 2 would have no bearing whatsoever on the final performance of the semiconductor device. Design layout referencing functions implemented in conventional inspection apparatuses or inspection support apparatuses were without a function for differentiating between wiring patterns relevant to the operation of the device and irrelevant patterns, and there was thus a problem in that apparatus users were unable to identify truly critical defects.

An inspection support apparatus of the present embodiment solves the problems above. The above-mentioned problems are solved by differentiating semiconductor design layout data into layout data that is actually relevant to the circuit or operation of the semiconductor device and layout data that is not, and by so generating a background image onto which defects are to be projected that the apparatus user would be able to identify patterns that directly affect device characteristics and patterns that do not, or active patterns and dummy patterns. Thus, the process of extracting defects of truly high criticality from detected defect data becomes easier, and an inspection support apparatus capable of determining whether a semiconductor fabrication process is good or bad with higher precision is realized.

A specific configuration of the present embodiment is described below with reference to the drawings.

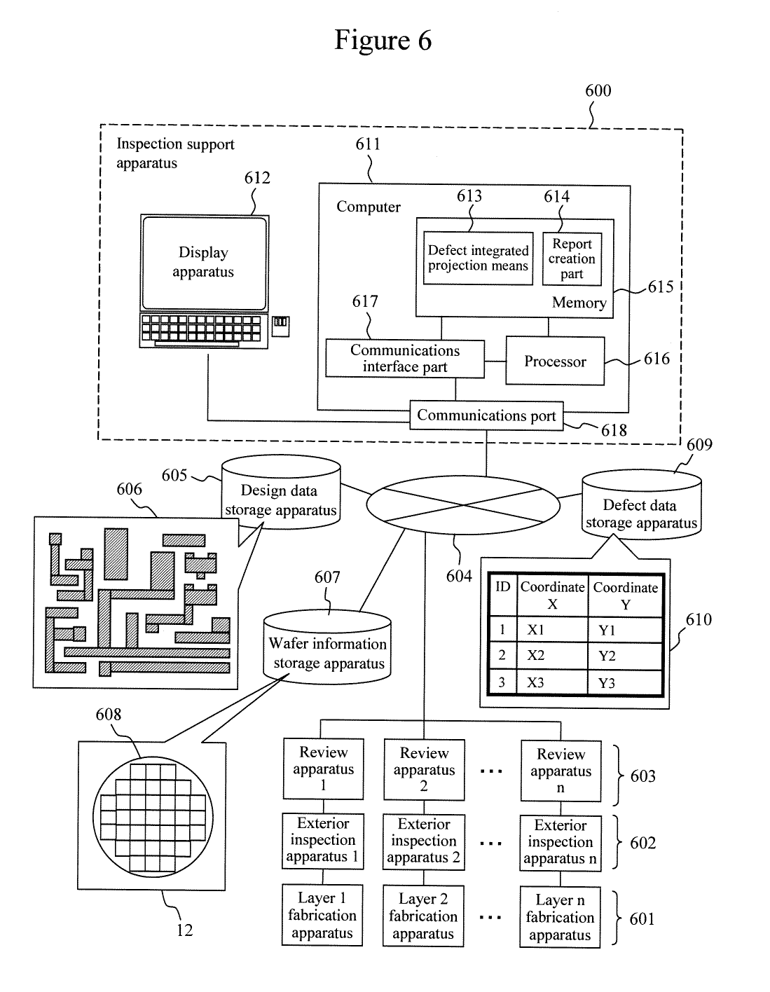

FIG. 6 is a diagram showing an environment in which an inspection support apparatus 600 of the present embodiment is located and the internal configuration of the inspection support apparatus. The inspection support apparatus 600 of the present embodiment is such that a design data storage apparatus 605, a wafer information storage apparatus 607 and a defect data storage apparatus 609 are connected via a communications network 604. Further, these information storage apparatuses are connected, via the communications network 604, to, for example, various layer fabrication apparatuses 601 which are semiconductor device fabrication equipment, such as a layer 1 fabrication apparatus, a layer 2 fabrication apparatus . . . a layer n fabrication apparatus, to exterior inspection apparatuses 602, such as a layer 1 exterior inspection apparatus, a layer 2 exterior inspection apparatus . . . a layer n exterior inspection apparatus which execute exterior inspection of the respective layers mentioned above, and to review apparatuses 603, such as a layer 1 review apparatus, a layer 2 review apparatus . . . a layer n review apparatus that acquire high-magnification review images of defect candidate locations acquired at the exterior inspection apparatuses for the respective layers mentioned above and execute ADC.

The defect location information detected at the exterior inspection apparatuses 602 are assigned a defect ID for each newly detected defect and stored in the defect data storage apparatus 609. At the same time, the wafer ID of the wafer on which inspection was performed, and a process ID, which indicates which wafer having undergone which process from among the fabrication processes for the semiconductor device the inspection has been executed with respect to, are also stored in the defect data storage apparatus 609. The defect review apparatuses acquire, with respect to defects of the respective defect IDs, images of just enough resolution to allow for an understanding of the detailed structures of the defects, and execute ADC based on the acquired images. Associated information on the defects obtained as a result of ADC, e.g., defect type information, defect size and defect center location data, magnification information of the image used in order to execute ADC, etc., are stored in the defect data storage apparatus 609 along with such IDs as wafer IDs and process IDs.

Location information of various regions of dies and chips on a wafer and of design circuit patterns and design cells (functional cells) on chips, wafer IDs and chip IDs as identification information for wafer and chips, fabrication step information, imaged data, etc., are stored in the wafer information storage apparatus 607. In addition, besides pattern data indicating design patterns, there are stored in the design data storage apparatus 605 identifiers indicating local regions of design layouts, such as die IDs, chip IDs, cell IDs, etc., layer IDs as identification information for the layers to which design patterns belong, process IDs as fabrication step information for design layout data, mask IDs as mask information, etc.

The inspection support apparatus 600 of the present embodiment comprises a computer 611 having a function for executing various processes necessary for defect determination, and a display apparatus 612 on which a GUI for entering settings necessary for defect determination and determination results are displayed. The display apparatus also comprises such input devices as a keyboard and a mouse for the apparatus user to operate the GUI screen. The computer 611 comprises: a memory 615 in which software for realizing key functions of the inspection support apparatus of the present embodiment is stored; a processor that runs the software stored in the memory; a communications interface part 617 that executes communications processing with various information storage apparatuses (servers) connected to the communications network 604; and a communications port 618 to which physical wiring for connecting to the communications network 604 is connected. In FIG. 6, two examples of software that realize key functions of the inspection support apparatus of the present embodiment are provided, namely, a defect projection means that executes defect determination, and a report creating part for outputting defect determination results in report format. However, this does not in any way indicate that no other functions are implemented.

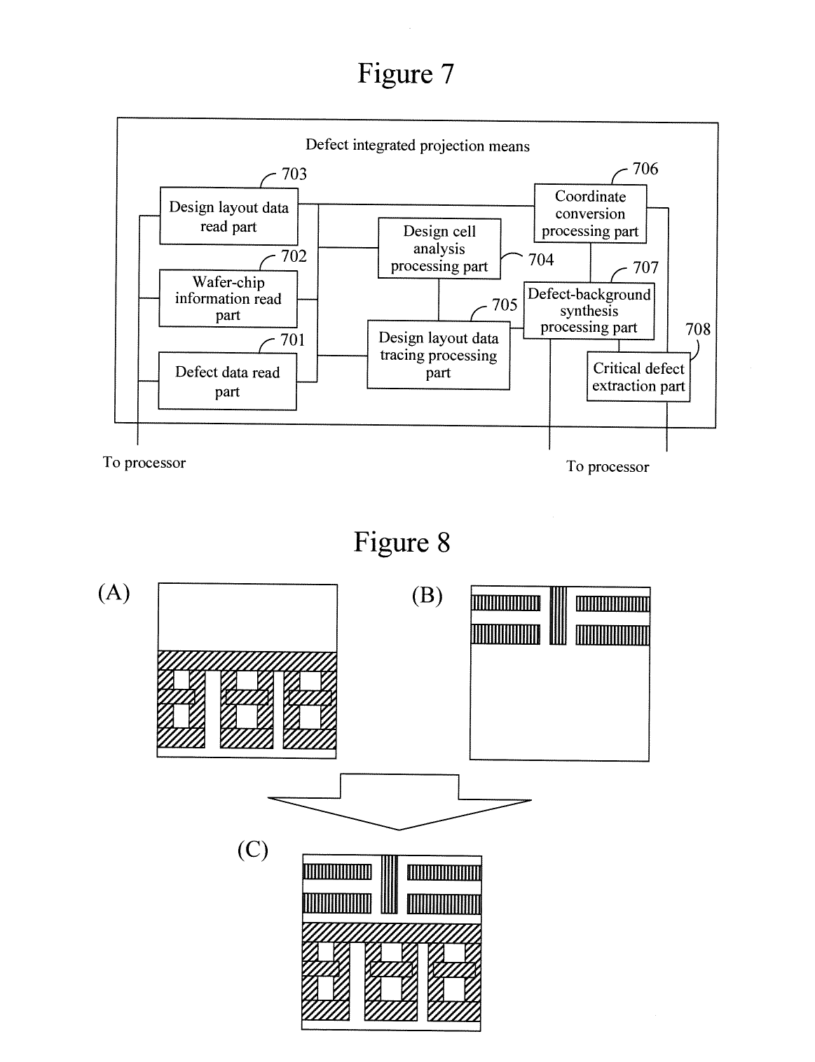

In FIG. 7, there are shown functional blocks that are deployed in the memory space of the memory 615 shown in FIG. 6. In addition, for purposes of convenience, the functional blocks shown in FIG. 7 are shown as if they are formed within the memory 615. However, in reality, the functional blocks shown in FIG. 7 are realized by having software stored in the memory 615 run by the processor. Operations of the functional blocks of FIG. 7 are described below in accordance with the order in which criticality is determined with respect to defect information that is provided.

Once the inspection support apparatus 600 is started, a wafer ID input box and a process ID input box prompting entry of the wafer ID for the wafer on which defect determination is to be performed and of a process ID are displayed on a GUI screen displayed on the display apparatus 612. As the apparatus user enters the desired wafer ID and process ID, a defect data read part 701 generates a defect data acquisition request with the wafer ID and process ID as reference keys. This acquisition request is formatted in the form of a request packet at the communications interface 617, and is transmitted to the defect data storage apparatus 609 via the communications network 604. In the form of a reply to the request packet, the defect data storage apparatus 609 replies with the defect data corresponding to the requested wafer ID and process ID. Defect data is stored within the defect data storage apparatus 609 in such a manner as to each include a defect ID, X coordinate information and Y coordinate information for the defect corresponding to that defect ID, and, further, image data of a local region including the defect, and is stored, by way of example, in such a format as that of a defect table 610 shown in FIG. 6. In addition, location information of a reference location for origin alignment, such as a center location or orientation flat location of the wafer, or some appropriate die corner location on the wafer, is also included in the form of associated information.

Once the defect data 610 is acquired, the GUI screen on the display apparatus 612 transitions to an origin alignment execution screen. The acquired defect location information is displayed on the origin alignment execution screen in the form of a defect map over a circular diagram representing the entire wafer. Defects on the defect map are displayed in a manner visible to the apparatus user, such as through color-coding, by varying dot shapes, etc., in accordance with the type information of the defects as identified through ADC.

The diagram displayed on the GUI at this point and indicating the defect locations on the defect map and the entire wafer is at a location expressed through the coordinate system that the inspection support apparatus 600 has, and is merely displayed in such a manner that the center of the wafer as a whole falls at the center of the view field of the display. In performing origin alignment, location information included in the defect data 610 and which is information of locations that may be used for alignment is displayed on the GUI as a guide, and the apparatus user specifies, in accordance with the guide and with respect to the defect map, a reference point for executing origin alignment. For purposes of brevity, it is assumed in the present embodiment that the center location of the wafer has been specified as a reference point for origin alignment. Once a reference location for origin alignment is specified, a coordinate conversion processing part 706 calculates the difference between the coordinates of the reference location as expressed through the coordinate system that the inspection support apparatus 600 has and the coordinates of the reference location included in the defect data 610, thereby finding an origin alignment amount. The coordinate origin that the inspection support apparatus 600 has is thus aligned with the coordinate origin that the inspection apparatus that executed defect detection (e.g., a defect review apparatus, an exterior inspection apparatus, etc.) has. The origin alignment that is executed at this point is alignment for aligning the coordinate origin that the inspection support apparatus 600 has with the coordinate origin that the inspection apparatus that executed defect detection has, and will be referred to below as the first origin alignment.

After the first origin alignment is finished, there is displayed on the GUI screen on the display apparatus 612 a region specifying screen for specifying a region with respect to which a defect determination is to be performed. The specifying of a region is executed by enclosing, with respect to a defect map of the wafer as a whole and using a pointer, a location with respect to which a defect determination is to be executed. The specifying of a region is performed because defects that occur in semiconductor device fabrication processes are such that locations at which they occur tend to be distributed across particular regions on a wafer depending on the type of the defects, and the apparatus user may not necessarily wish to perform a defect determination for the entire surface of the wafer.

When the specifying of a region is executed, a wafer-chip information read part 702 first requests, with respect to the wafer information storage apparatus 607, the die ID and location information of the wafer, as well as the reference location that has been specified during the first origin alignment. This request is also formatted in the form of a request packet at the communications interface 617, and is transmitted to the wafer information storage apparatus 607 via the communications network 604. In the form of a reply to the request packet, the defect data storage apparatus 607 replies with location information of the die corresponding to the requested die ID and reference location information for origin alignment. The returned data packet has its data part extracted at the communications interface 617, returned to the wafer-chip information read part 702, and further forwarded to the coordinate conversion processing part 706.

The coordinate conversion processing part 706 executes, in the aforementioned manner, origin alignment with respect to the coordinate system through which the design layout data is described, and aligns the coordinate origin that the inspection support apparatus 600 has with the coordinate origin of the location information stored in the wafer information storage apparatus 607. This operation will be referred to below as the second origin alignment. After calculating the second origin alignment, the coordinate conversion processing part 706 converts the acquired die location information to the coordinate system that the inspection support apparatus 600 has. The die location information as converted and the die ID are returned to the wafer-chip information read part 702.

Using the returned die location information, the wafer-chip information read part 702 executes a process of extracting the die IDs of dies included in the specified region, and requests, with respect to the wafer information storage apparatus 607 and for the dies of the extracted IDs, the IDs and location information of all chips and cells included in each die. This request is also transmitted to the wafer information storage apparatus 607 via the communications interface 617, and the wafer information storage apparatus 607 returns, with respect to the dies of the specified IDs, the chip IDs and chip location information included inside the dies. The wafer-chip information read part 702 forwards to a design layout data read part 703 the process ID and wafer ID for the wafer currently undergoing defect determination, the die IDs, and the returned chip IDs.

With the acquired process ID, wafer ID, die IDs and chip IDs as search keys, the design layout data read part 703 requests the design data storage apparatus 605 to transmit the corresponding design layout data. This request is also transmitted to the design data storage apparatus 605 via the communications interface 617, and the design data storage apparatus 605 returns to the design layout data read part 703 the design layout data corresponding to the requested wafer ID, process ID, die IDs, chip IDs and cell IDs. As described in connection with FIGS. 5(A) through 5(E), there exists a plurality of design layout information included in the same process ID. Therefore, the design layout data returned from the design data storage apparatus 605 includes design layout data having a plurality of layer IDs corresponding to a plurality of design layout information. Accordingly, correspondence information indicating how the design layout information of which layer ID is data with what kind of function (e.g., classification into active patterns and dummy patterns) is also transmitted from the design data storage apparatus 605. The design layout data read part 703 further forwards the returned data to a design cell analysis processing part 704.

Using the above-mentioned correspondence information, the design cell analysis processing part 704 executes a process of assigning to the acquired design layout data an identifier for classification as an active pattern or dummy pattern. It thus becomes possible for the inspection support apparatus 600 to identify the class of the acquired design layout data.

The assigned identifier information is transmitted to a design layout data tracing processing part 705, and a diagram of a design pattern, which is to serve as a background to be synthesized with defect information, is generated. This operation is, by way of example, as shown in FIGS. 5(A) through 5(E).

In FIGS. 5(A) through 5(E), it is shown that a layer formed by a fabrication process of a given process ID comprises four patterns, namely of a lower layer, an intermediate layer, an upper layer 2 and an upper layer 1, and distinct layer IDs are assigned to the respective patterns, such as, for example, identifiers like layer 1, layer 2, layer 3 and layer 4 in order from the bottom. With respect to the identifiers “layer 1, layer 2, layer 3, layer 4,” the design cell analysis processing part 704 further assigns identifiers as in “layer 1=1, layer 2=0, layer 3=0, layer 4=0.” In this case, “1” is an identifier signifying a dummy pattern, and “0” is an identifier signifying an active pattern.

The design layout data tracing processing part 705 generates a background pattern by differentiating between active patterns and dummy patterns by way of the classification code (identifier) of the design layout data assigned by the design cell analysis processing part 704. “Generates by differentiating” refers to, by way of example, processes such as generating color-coded active patterns and dummy patterns, but other representation formats are also possible so long as the format allows for differentiation by the apparatus user. In FIGS. 8(A) through 8(C), it is shown how patterns of a plurality of layer IDs included in a given process ID are grouped into FIG. 8(A) of design patterns corresponding to active patterns and into FIG. 8(B) of design patterns corresponding to dummy patterns by the design layout data tracing processing part 705. FIG. 8(C) is a schematic diagram showing how the patterns shown in FIG. 8(A) and the patterns shown in FIG. 8(B) are further superimposed, and a defect image and defect location information are synthesized over a background image such as that of FIG. 8(C).

The generated background pattern is transmitted to a defect-background synthesis processing part 707. At the same time, location information of defect locations that have been converted to the coordinate system that the inspection support apparatus 600 has is forwarded from the coordinate conversion processing part 706 to the defect-background synthesis processing part 707, and image information of defects is forwarded from the defect data read part 701 to the defect-background synthesis processing part 707. Based on magnification information included in the acquired image information, the defect-background synthesis processing part 707 performs a display size adjustment process to match the display sizes of the acquired image and the background image, and, further, executes a process of synthesizing the background image, the defect image, and the defect location information. The synthesized defect integrated projection image is displayed as a result on the GUI screen and is used by the apparatus user to visually determine the criticality of the detected defect. In addition, data for a defect ID to which an identifier for differentiating between active patterns/dummy patterns is assigned is updated in the defect data storage apparatus, and is referenced when executing ADC with respect to wafers on which similar circuit patterns are formed.

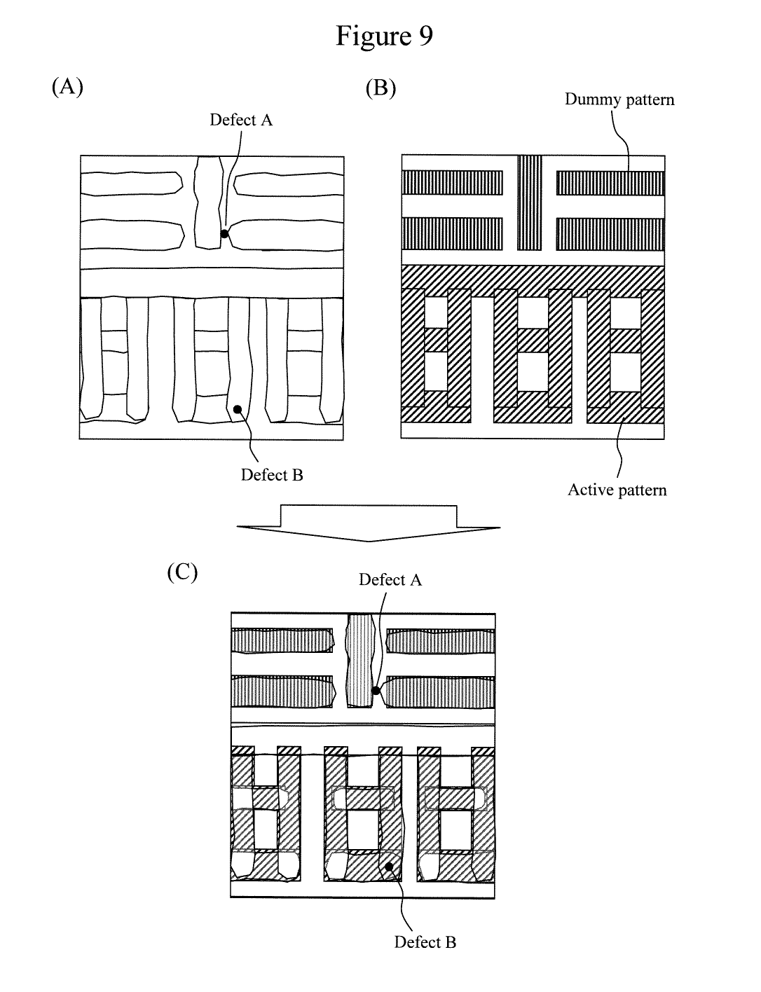

FIGS. 9(A) through 9(C) schematically show an inspection image (A) before being synthesized into a defect integrated projection image, wiring patterns (B) as designed which are to serve as the background, and a defect projection image (C) after the defect-background synthesizing process. Since it can be visually determined that defect A that is present in the inspection image (A) is present in a dummy pattern region (the pattern with vertical hatching in Figure (B)) with respect to the defect projection image (C), the apparatus user is able to determine that defect A is a non-critical defect. On the other hand, defect B that is present in the inspection image (A) is present in an active pattern region (the pattern with oblique hatching in Figure (B)) with respect to the defect projection image (C), it can be determined that it is a critical defect.

It is also possible to only display critical defects on the result display screen displayed on the GUI. On the GUI screen on which a defect projection image is displayed as a result, it becomes possible for the user to select a defect from this list to define the defect type or classification identifier based on the design wiring pattern and the inspection image. Specifically, it is determined with ease and defined whether it is a defect in an active pattern or a defect in a dummy pattern. It becomes possible to have this determination process automatically calculated by incorporating a calculation process based on wiring patterns and defect coordinates. As the user narrows down the list by defect type or classification identifier, a critical defect extracting part 708 shown in FIG. 7 extracts only those defects that meet those conditions. Thus, the extraction result at the critical defect extracting part 708 is forwarded to the design layout data tracing processing part 705, and the defect integrated projection image to be displayed on the GUI screen is displayed with defects at coordinates corresponding to dummy patterns masked therefrom. Alternatively, it may be arranged such that the defects at the coordinates corresponding to dummy patterns are not displayed.

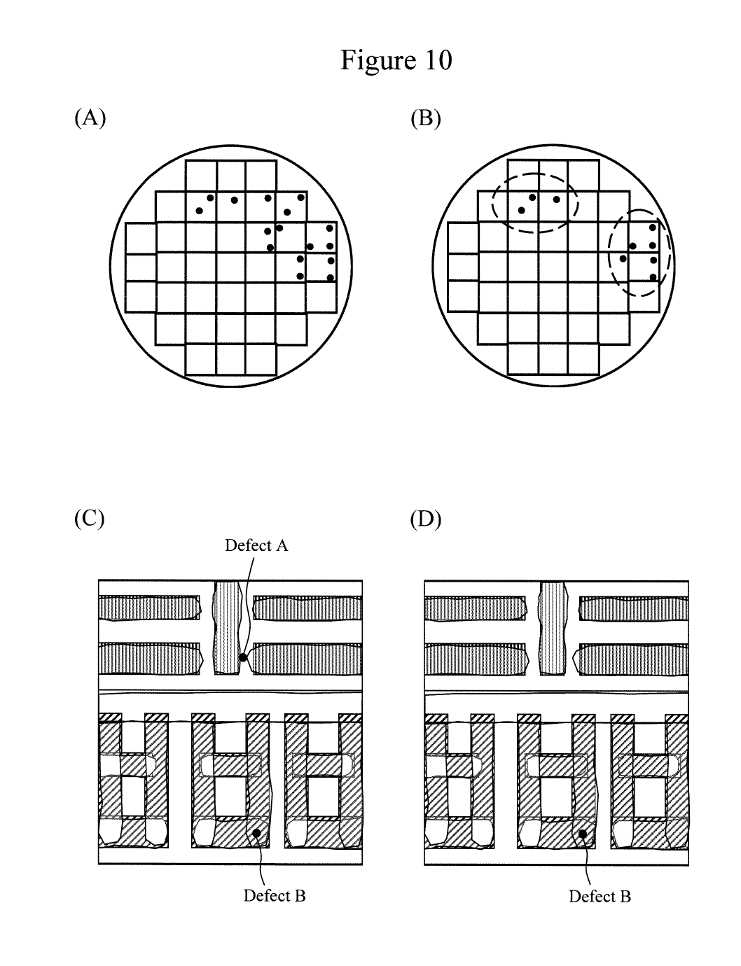

In FIGS. 10(A) through 10(D), an example of screening results displayed on the screen after execution of a critical defect screening process is shown by way of a pre-/post-execution comparison. FIGS. 10(A) and (B) show screening results in a defect map format showing the entire wafer, and FIGS. 10(C) and (D) in a format where a portion of a cell is enlarged. In FIG. 10(B), display is performed with non-critical defects removed, as a result of which it can be seen that the distribution region of critical defects is better defined as compared to FIG. 10(A).

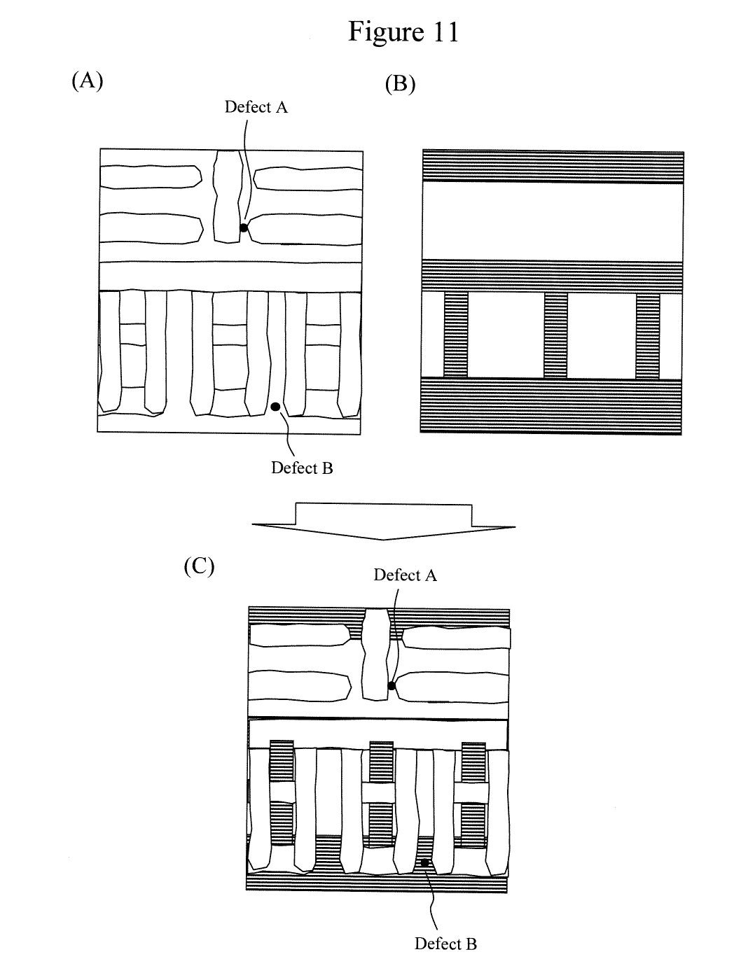

In the defect integrated projection process, the design layout data to be synthesized with the inspection image is not necessarily restricted to data of the same layer, and it is also possible to synthesize data of different layers. In FIGS. 11(A) through 11(C), it is shown how a design pattern of a downstream step, that is, a design pattern of a layer that is yet to be formed over a layer for which an inspection image has been acquired, is synthesized. Descriptions of the origin alignment process and coordinate conversion process, etc., for synthesis will not be reiterated here since they are the same as for when layout data of the same layer is synthesized.

FIG. 11(A) shows an inspection image, FIG. 11(B) shows design layout data of a downstream step (for purposes of brevity, it is assumed that all are active patterns), and FIG. 11(C) shows a defect integrated projection image after synthesis. The two defects A and B shown in FIG. 11(A) are both defects that lie between wires, and are both recognized as being non-critical defects with respect to the inspection image. However, with respect to FIG. 11(C), defect A is present where there are no patterns in the design pattern of the downstream step, and defect B is present where there is a pattern. Accordingly, it can be determined that defect A has no bearing on the downstream step, whereas defect B would likely have some impact on the downstream step.

With respect to defect integrated projection images involving design layout data of other layers such as the one shown in FIG. 11(C), a synthesizing process is started by, for example, displaying a button such as “correlation with other layers” on the GUI, and having the apparatus user indicate whether or not acquisition of a defect integrated projection image of another layer is necessary and IDs of layers with which correlation is to be observed (e.g., process ID and layer ID). Descriptions of the processes that are executed at this point will be omitted since they are identical to the processes that have already been discussed except that the design layout data read part 703 acquires design layout data using a process ID that is entered through the GUI and not a process ID acquired by the defect data read part 701. In addition, differentiated display of active patterns/dummy patterns is obviously possible with respect to design layout data of other layers as well.

### LIST OF REFERENCE NUMERALS

1 Computer system
2 Defect integrated projection means
3 Defect integrated projection display apparatus
4 Defect integrated projection instruction information input apparatus
5 Design layout data storage apparatus
6 Wafer data storage apparatus
7 Defect data storage apparatus

1. A semiconductor defect inspection support apparatus, comprising:
a design layout data read part that acquires design layout data including location information of design circuit patterns to be used in semiconductor fabrication steps;
a wafer-chip information read part that acquires, from among data concerning a wafer on which a plurality of the design circuit patterns are formed per chip, wafer-chip information including at least design cell location information;
a defect data read part that acquires defect data including location information of defects that occurred in the steps;
a design layout data tracing processing part that creates a design layout data defect integrated projection display view by performing, based on the design layout data and the wafer-chip information, an integrated projection process on, among the design layout data, design layout data for a step in which a defect occurred and the defect data; and
a defect integrated projection display apparatus that displays the design layout data defect integrated projection display view.

2. A defect inspection support apparatus that is used by being connected to a plurality of information storage apparatuses in each of which are stored inspection results of defect locations with respect to circuit patterns of a plurality of layers forming a semiconductor device and design layout information with respect to the circuit patterns of the plurality of layers, and that executes a supporting operation for the defect inspection by displaying on a screen the inspection results and design layout information, the defect inspection support apparatus comprising:
means that, using coordinate information of a predetermined reference location, executes first origin alignment that aligns a coordinate origin of a coordinate system through which the defect locations are described and a coordinate origin of a coordinate system that it has itself, and second origin alignment that aligns a coordinate origin of a coordinate system through which the design layout information is described and the coordinate origin of the coordinate system that it has itself;
means that generates a defect integrated projection image by synthesizing a circuit pattern obtained from the design layout information with the defects; and
screen display means that displays the defect integrated projection image.

3. A defect inspection support apparatus according to claim 2, wherein
an input box for entering identification information for specifying a layer to which the circuit pattern that is to serve as a background for the defect integrated projection image belongs is displayed on the screen display means, and
the defect inspection support apparatus further comprises a design layout data read part that makes a request to the information storage apparatuses for design layout information of a layer corresponding to the identification information that has been entered, and that acquires the design layout information.

4. A defect inspection support apparatus according to claim 2, wherein, as defect integrated projection images, at least two can be generated, the two being at least a semiconductor wafer as a whole and a local region of the semiconductor wafer.

5. A defect inspection support apparatus according to claim 4, wherein
design layout information of the local region comprises a unique coordinate system corresponding to the size of the local region, and
the defect inspection support apparatus comprises means that performs coordinate conversion for converting the coordinates of the defect location to the unique coordinate system corresponding to the size unit of the local region.

6. A defect inspection support apparatus according to claim 5, wherein the size unit of the local region comprises a die unit, a chip unit, and a cell unit.

7. A defect inspection support apparatus according to claim 2, wherein a background image for the defect integrated projection image is generated by classifying the circuit patterns into an active pattern and a dummy pattern included in the patterns.

8. A defect inspection support apparatus according to claim 7, wherein a defect displayed in a superimposed manner on the dummy pattern is displayed by being masked on the screen display means.

9. A defect inspection support apparatus according to claim 7, comprising a function for displaying only a defect that is present in the active pattern through screening.
